(19) United States
(12) Patent Application Publication
(10) Pub. No.: US 2005/0131794 A1
(43) Pub. Date: Jun. 16, 2005

(54) Stock portfolio and method

(76) Inventor: Kalman A. Lifson, Dallas, TX (US)

Correspondence Address: BAKER BOTTS L.L.P., 2001 ROSS AVENUE, SUITE 600, DALLAS, TX, 75201-2980, US

(21) Appl. No.: 10/736,723

(22) Filed: Dec. 15, 2003

(51) Int. Cl. G06F 17/60

(52) U.S. Cl. 705/36

(57) ABSTRACT

One aspect of the invention is a method for investing. An equation is created using multivariate regression techniques to calculate a plurality of coefficients each associated with one of a plurality of statistic types that is correlated with actual market prices of the plurality of stocks. At least some of the plurality of statistic types comprise financial information, other than the particular stock's past market price, specific to the entity associated with the particular stock. The equation is then used to estimate the degree to which ones of the plurality of stocks are over-priced or under-priced relative to the price of other ones of the plurality of stocks. These estimates may then be used to make investment decisions.

### TECHNICAL FIELD OF THE INVENTION

This invention relates generally to investing and more particularly to a portfolio and method for choosing items in the portfolio.

### BACKGROUND OF THE INVENTION

Curve fitting techniques have been used in the past as a basis for investing in stocks. Most often, these techniques involve using a series of past market prices over particular time intervals to predict future price moves. However, some people believe these types of models have questionable predictive value because they focus simply on a single variable and because past performance may not be a good indicator of future performance.

### SUMMARY OF THE INVENTION

One aspect of the invention is a method for investing. An equation is created using multivariate regression techniques to calculate a plurality of coefficients each associated with one of a plurality of statistic types that is correlated with actual market prices of the plurality of stocks. At least some of the plurality of statistic types comprise financial information, other than the particular stock's past market price, specific to the entity associated with the particular stock. The equation is then used to estimate the degree to which ones of the plurality of stocks are over-priced or under-priced relative to the price of other ones of the plurality of stocks. These estimates may then be used to make investment decisions.

The invention has several important technical advantages. Various embodiments of the invention may have none, one, some, or all of these advantages without departing from the scope of the invention. The invention uses techniques commonly employed in the social sciences to estimate the degree of importance that the market attaches to a particular statistic associated with a particular stock. Thus, the invention employs what may be commonly referred to as a policy capturing model. By employing a policy capturing model, the invention may increase the accuracy of the prediction whether or not a stock is overvalued or undervalued relative to the universe of stocks being analyzed because the model takes into account the collective view of those buying and selling a particular group of stocks as to the importance of one or more financial statistics to the price of the stocks in the group. Thus, the invention may allow creation of a portfolio of stocks, futures, and/or options whose performance is better than the universe of stocks being analyzed as a whole.

### BRIEF DESCRIPTION OF THE DRAWINGS

For a more complete understanding of the present invention and the advantages thereof, reference is now made to the following descriptions taken in conjunction with the accompanying drawings in which:

FIG. 1 illustrates a block diagram of a general purpose computer that may be used in accordance with the present invention;

FIG. 2 illustrates an example architecture of a system that may be used to create a policy capturing model for use with the present invention; and

FIG. 3 illustrates a method of creating a policy capturing model for investing in stocks, options, and/or futures in accordance with the present invention.

### DETAILED DESCRIPTION OF THE INVENTION

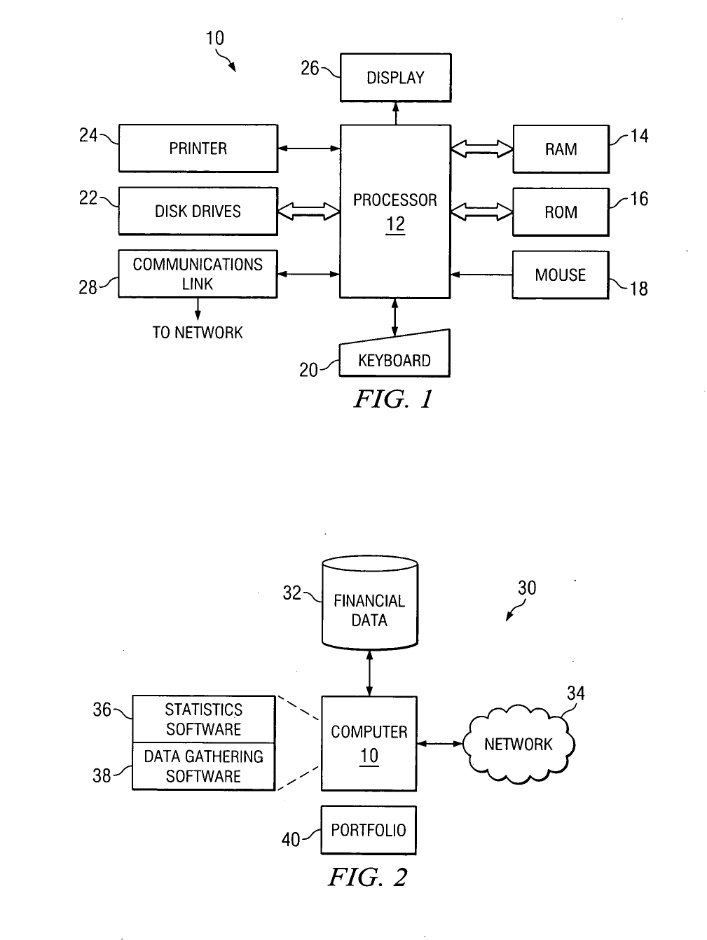

The preferred embodiment of the present invention and its advantages are best understood by referring to FIGS. 1 through 3 of the drawings, like numerals being used for like and corresponding parts of the various drawings.

FIG. 1 illustrates a general purpose computer 10 that may be used in connection with one or more of the pieces of software employed by the present invention. General purpose computer 10 may be adapted to execute any of the well known OS2, UNIX, Mac-OS, Linux, and Windows operating systems or other operating systems. General purpose computer 10 comprises processor 12, random access memory (RAM) 14, read only memory (ROM) 16, mouse 18, keyboard 20 and input/output devices such as printer 24, disk drives 22, display 26 and communications link 28. The present invention may include programs that may be stored in RAM 14, ROM 16, or disk drives 22 and may be executed by processor 12. Communications link 28 may be connected to a computer network but could be connected to a telephone line, an antenna, a gateway, or any other type of communication link. Disk drives 22 may include a variety of types of storage media such as, for example, floppy disk drives, hard disk drives, CD-ROM drives or magnetic tape drives. Although this embodiment employs a plurality of disk drives 22, a single disk drive 22 could be used without departing from the scope of the invention. FIG. 1 provides one example of a computer that may be used with the invention. The invention could be used with computers other than general purpose computers as well as general purpose computers without conventional operating systems.

The invention includes logic contained within a medium. In this example, the logic comprises computer software executable on a general purpose computer. The medium may include one or more storage devices associated with general purpose computer 10. The invention may be implemented with computer software, computer hardware, or a combination of software and hardware. The logic may also be embedded within any other medium without departing from the scope of the invention.

The invention may employ multiple general purpose computers 10 networked together in a computer network. Most commonly, multiple general purpose computers 10 may be networked through the Internet and/or in a client server network. The invention may also be used with a combination of separate computer networks each linked together by a private or public network.

FIG. 2 illustrates an architecture of a system 30 that may be used to create a portfolio 40 in accordance with the invention. System 30 comprises computer 10, network 34, financial database 32, statistics software 36 and data gathering software 38.

Computer 10 may obtain financial data and store the financial data in financial database 32. Computer 10 may obtain such financial data using network 34. Network 34 may be the Internet, another network connected to the Internet, or a client server network with access to financial data. Alternatively, financial data may be obtained using a portable storage media such as a floppy disk, CD-ROM, portable hard drive, DVD-ROM, or any other type of portable storage media. Where portable storage media is used, the data may be transferred to a financial database 32 and/or used with the portable storage media directly.

System 30 further includes computer software executable on computer 10. As noted above, one or more computers 10 may be used without departing from the scope of the invention. In this embodiment system 30 includes data gathering software 38. Data gathering software 38 may be omitted without departing from the scope of the invention. For example, data gathering software 38 may be omitted if financial data for financial database 32 is obtained using a portable storage media. Where data gathering software 38 is used, data gathering software may comprise for example, a web browser. Alternatively, data gathering software 38 may comprise a dedicated piece of software used to gather the particular financial statistics stored in financial database 32. Data gathering software may be used to retrieve the relevant financial data from one or more computers networked to computer 10 through network 34. In this embodiment, data gathering software 38 may be used, for example, to obtain financial data for financial institutions that is required by law to be reported to the federal government. This data may be obtained over computer network 34.

Statistics software 36 may be used to perform a multivariate regression analysis (such as a multiple linear regression) on various financial data stored in financial database 32. While not explicitly shown, an intermediate piece of software such as a spreadsheet program, like Microsoft EXCEL may be used to organize the data analyzed by statistics software 36. While this embodiment may employ multiple linear regression techniques, other multivariate regression techniques may be performed without departing from the scope of the invention. Generally, other multivariate regression techniques will use more than one independent variables. While the examples below use actual values of the independent variables, functions of the independent variables could also be used without departing from the scope of the invention. For example, the logarithm, cosine, sine, tangent of a particular value could be used. In addition, a particular value could be an ordinal or a categorical value converted to a cardinal value.

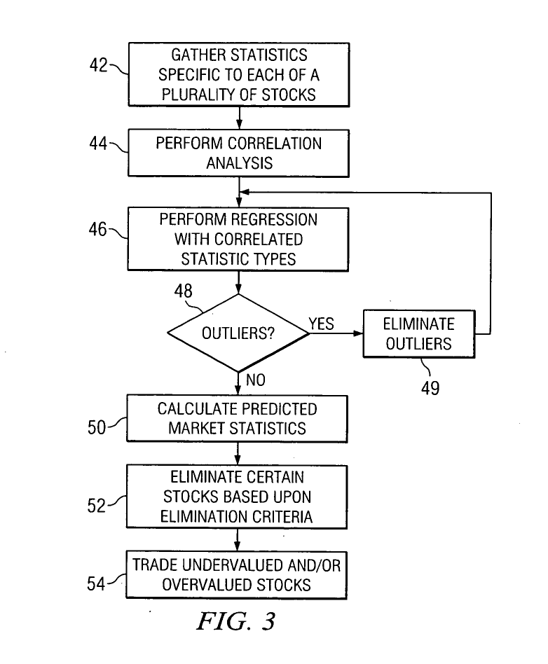

FIG. 3 illustrates a method for investing in accordance with the present invention. In step 42 a plurality of statistics specific to each a plurality of stocks is gathered. The statistics gathered in step 42 may include, for each stock, a recent market price and one or more past market prices of a particular stock. In addition, a number of additional statistics may be gathered which comprise financial information specific to the business entity associated with the particular stock. Statistics gathered may also include, for example, items such as insider trades, ownership, credit ratings, and/or the stock exchange that a stock is traded on.

Ordinarily, the invention will be used with a set of stocks wherein the entities associated with the set of stocks are all in a particular industry and wherein the set is large enough to provide statistical reliability. For example, in this embodiment, the invention may be used with a set of stocks of financial institutions. However, the invention could be used with a group of stocks associated with any particular industry. Preferably, the invention may be used with a set of stocks where common data values for each stock are available and wherein the common data values are generally calculated in the same manner for each particular stock.

The federal government requires financial institutions (specifically commercial banks and thrift institutions) to report various statistics to the federal government on a quarterly basis. Most of the statistics are objectively verifiable numerical values. In other words, the statistics represent factual information which is fairly consistently calculated and reported across institutions. The invention will likely produce the best results when objective, consistently calculated and reported statistics are used. Certain statistics may add more subjectivity into the process. Where subjectivity is introduced, the invention may produce less accurate results because the subjective statistics have a high degree of variability in their accuracy.

As noted above, the invention typically uses financial information where a value for each entity in a group may be obtained. However, the invention may also be used with financial statistics which are not specific to a particular entity but which apply to all entities as a whole. For example, statistics such as the current prime interest rate, the rate of inflation, the unemployment rate, a currency exchange rate, the rate of growth in a particular industry represented by the group of stocks, etc. are statistics that might be used with the present invention. Thus, both individual statistics and aggregate statistics may be used without departing from the scope of the invention.

As discussed above, one embodiment of the invention gathers financial statistics for financial institutions. The statistics gathered may include, for example, a recent market price of each of a plurality of financial institution stocks as well as past market prices over various time intervals for each of the plurality of stocks. In addition, the data gathered may include the values in the following table of values. For convenience, a variable symbol has been assigned to each statistic as various formulas below employ some of these statistics.

TABLE 1

| Variable | Description |
|---|---|
| D | Recent Market Price |
| L | Last 12 Months Dividend Payout Ratio (%) |
| M | Price/Earnings |
| N | Price/Book Value (%) |
| O | Price/Last 12 Months Core Earnings Per Share |
| P | Price/Current Quarter Core Earnings Per Share |
| Q | Book Value Per Share Current Quarter |
| S | Diluted Earnings Per Share After Extraordinary |
| | Items Current Quarter |
| T | Diluted Earnings Per Share After Extraordinary |
| | Items Last 12 Months |
| U | Core Earnings Per Share Current Quarter |
| V | Core Earnings Per Share Last 12 Months |
| W | Efficiency Ratio Current Quarter (%) |
| X | Efficiency Ratio Last 12 Months (%) |
| Y | Efficiency Ratio Same Quarter Last Year (%) |
| Z | Return on Average Equity Current Quarter (%) |
| AA | Return on Average Equity Last 12 Months (%) |
| AB | Core Return on Equity Current Quarter (%) |
| AC | Core Return on Equity Last 12 Months (%) |
| AD | Earnings Per Share Growth Current Quarter (%) |
| AE | Earnings Per Share Growth Last 12 Months (%) |
| AF | Core Earnings Per Share Growth Current Quarter |
| | (%) |
| AG | Core Earnings Per Share Growth Last 12 Months |
| | (%) |
| AH | Noninterest Income/Operating Revenue Current |
| | Quarter (%) |
| AI | Noninterest Income/Operating Revenue Last 12 |
| | Months (%) |
| AJ | Total Equity/Total Assets Current Quarter (%) |
| AK | Loans/Deposits Current Quarter (%) |
| AL | Tangible Book Value Per Share Current Quarter |
| AN | Reserves/Loans Current Quarter (%) |
| AO | Reserves/Nonperforming Assets Current Quarter |
| | (%) |
| AQ | Total Servicing Rights Current Quarter |
| AT | Service Charges on Deposits Current Quarter |
| AU | Gain or Loss on Sale of Loans Current Quarter |
| AY | Service Charges on Deposits Last 12 Months |
| AZ | Gain or Loss on Sale of Loans Last 12 Months |
| BF | Amortization of Intangibles Current Quarter |
| BG | Amortization of Intangibles Last 12 Months |
| BJ | Common Shares Outstanding Current Quarter |
| BK | Total Borrowings/Total Assets Current Quarter |
| | (%) |
| BL | Intangibles/Equity Current Quarter (%) |
| BO | Nonoperating Income/Net Income Before Taxes |
| | Current Quarter (%) |
| BP | Nonoperating Income/Net Income Before Taxes |
| | Last 12 Months (%) |
| BS | Plowback Ratio Current Quarter (%) |
| BT | Plowback Ratio Last 12 Months (%) |
| BX | Deposit Growth Current Quarter (%) |
| BY | Deposit Growth Last 12 Months (%) |
| BZ | Price/Book Value Same Quarter Last Year (%) |
| CA | Share Price End of Same Quarter Last Year |
| CC | Consumer and Industrial Loans/Total Loans Last |
| | Quarter Reported (%) |
| CD | Nonperforming Loans/Total Loans Last Quarter |
| | Reported (%) |
| CE | Nonperforming Assets/Total Loans Last Quarter |
| | Reported (%) |
| CF | Nonperforming Assets/Total Assets Last Quarter |
| | Reported (%) |
| CH | (Nonperforming Assets + Loans 90 Days Past |
| | Due)/Total Assets Last Quarter Reported (%) |
| CI | Mortgage Servicing Rights Last Quarter |
| | Reported |
| CK | Restructured Loans/Total Loans Last Quarter |
| | Reported (%) |
| CM | Foreclosed Real Estate/Total Assets Last |
| | Quarter Reported (%) |
| CN | (Credit Cards + Related Plans)/Total Loans |
| | Last Quarter Reported (%) |
| CO | Rate Sensitive Assets Last Quarter Reported |
| CP | Rate Sensitive Liabilities Last Quarter |
| | Reported |
| CQ | Total Equity Cap |
| coverbig | an/(0.93 + .342cd + .014cc + .046*cn) |
| othnpa | ch-ck |
| mshares | bj/1000 |
| deffy2 | w/y |
| svcrit_s | aq/mshares |
| svcchg_s | at/mshares |
| mtgsvc_s | ci/mshares |
| amintnqs | bf/mshares |
| amintnys | bg/mshares |
| noncreq | s-u |
| noncrey | t-v |
| crelst3 | v-u |

As noted in Table 1, some of the statistics for each particular stock may be calculated using other statistics that were gathered for each particular stock. In some cases, the calculated statistics will be available to be gathered. In other cases, some of these values may be calculated. For a particular institution, some of the values will be missing. As an example, many financial institutions do not maintain a credit card portfolio so credit card statistics will be missing. Any missing values may be set to zero if that is logical. In the case of a statistic that is missing because it is not yet reported, then the most recent past value may be used in some cases.

Other statistics that may be used include the stock exchange that a financial institution trades on, tangible net worth ratio, the percentage of insider ownership, the percentage of institutional ownership, foreclosed real estate, nonperforming loans as a percentage of loans, loan loss provision as a percentage of revenue, amortization of intangibles as a percentage of revenue, service fees on deposits as a percentage of revenue, net operating income as a percentage of net income before taxes, yield, payout ratio, tangible net worth ratio, rate sensitivity ratio, and mortgage service rights as a percentage of equity.

In step 44, a correlation analysis is performed to determine the degree of correlation between various financial statistics and the market price of the stocks being analyzed. In addition to determining correlation between various statistics and market price, correlation may also be determined between the various statistics and the ratio of market price to some other financial measurement such as earnings, revenue, book value, assets, etc. In an embodiment where financial institution stocks are analyzed, the ratio of price to earnings and price to book value may be useful to correlate with other financial statistics for use in measuring over-valuation or under-valuation of certain stocks in the group as compared to the group as a whole. The correlation may be performed using computer software commonly available to those in the art for use in performing correlation measurements for a set of data values.

The correlation in step 44 may produce a set of correlation values which indicates the correlation among many different variables. In general, the regression analysis performed will use market price, price/earnings, price/book value, or price/some other financial statistic as dependent variables. Thus, to identify those statistics likely to be most useful for the regression analysis, a correlation threshold may be chosen below which certain statistic types are discarded for use in a particular regression. Thus, for a regression on market price, statistic types with a correlation below the threshold would be discarded for the market price regression. However, a statistic type thrown out for purposes of the market price regression could be used for purposes of the price/earnings regression if it was more highly correlated with the price/earnings value. In this embodiment, statistic types with a correlation coefficient having an absolute value less than 0.15 are discarded from the regression analysis but any threshold may be used without departing from the scope of the invention. In certain cases, a statistic type may be included even though its value is less than 0.15 where experience suggests that the statistic may have importance when other statistic types have been included.

In addition to eliminating statistic types with low correlation against the data to be used as dependent variables in the regression analysis, other statistic types may also be discarded. A desirable outcome of the regression analysis may be, for example, a solution that requires the fewest amount of variables to create a solution with a high f-ratio. Experience and logic may be used to eliminate certain statistic types from the equations. For example, efficiency for the last quarter and efficiency for the last year are likely to have a high degree of multi-colinearity. In other words, these data values are likely to be cross correlated and have similar predictive value for market price. While one of these variables could be eliminated for this reason by applying logic, one variable could also be eliminated by looking at the correlation data for the two values and selecting the statistic with the higher correlation value. The correlation data for these two values will likely show a high degree of correlation, suggesting that these variables have high colinearity. Thus, certain values may be eliminated from the regression analysis on this basis as well.

While this embodiment uses a correlation analysis to choose variables to be used in the regression, step 44 could be omitted without departing from the scope of the invention. Because step-wise linear regression may be used with the invention, the regression can eliminate statistic types with low significance in relation to the dependent variable or with high significance but also high co-linearity with other statistic types included in the regression.

In step 46, a multiple linear regression analysis is performed using, for example, the market price as the dependent variable and at least some other statistic types as independent variables (such as, for example, some of those discussed above in the case of financial institutions). While market price may be used as a dependent variable, other measures predictive of market value may be used such as price/earnings, price/book value, price/revenues, price/assets, or price/another financial measurement. Note also that steps 46-49 can be repeatedly performed for multiple dependent variables. In other words, steps 46-49 could be performed using market price, price/earnings, and price/book value as dependent variables.

In this embodiment, a stepwise linear regression is used. However, any type of multiple linear regression may be used without departing from the scope of the invention.

If correlation step 44 was omitted, then after the multiple linear regression has been performed in step 46, the significance of each of the various statistics used in the regression may be examined. Any statistic type with a confidence value over a particular threshold may be disregarded. In this embodiment, anything over a threshold of 0.05 gets disregarded. Any threshold may be selected (for example, based upon experience) without departing from the scope of the invention. Again, if certain statistic types are eliminated based upon the confidence value, the person performing the regression analysis could force these statistic types to be used in further iterations of the regression analysis.

Depending upon the particular time period at issue, the policy capturing model of the present invention may produce results such that statistic types that are significant and should be included in the equation to calculate an estimate of over-valuation or under-valuation during one time period are not significant and are disregarded during a different time period. This variance may reflect the changing emphasis on various statistics as reflective of market value by those investing in the particular group of stocks being analyzed. Thus, the particular statistics useful for estimating over-valuation or under-valuation may vary for each time period and various combinations of statistics may be tried using multiple linear regression and/or correlation analysis to identify the significant statistics.

For financial institutions, while the particular statistics that are significant may change from time to time, many of the above statistics have been found to be useful in at least some time periods.

In step 48, it is determined whether any outliers exist. If so, then the outliers may be eliminated in step 49. If not, then the method proceeds to step 50. Steps 48 and 49 may be eliminated without departing from the scope of the invention.

In step 49, outliers may be eliminated. An outlier may be a stock whose predicted market price, price to earnings ratio, price to book value ratio, etc. based upon the linear regression has a variance with its actual market price by more than a threshold amount. (This can also be observed by looking at the variance in ratios between the predicted value to the actual value.) While any threshold could be chosen, in this embodiment, stocks with a predicted market price more than 3.1 standard deviations different from their actual market price are eliminated from further regression calculations but may still be included (or not) for the calculations and trading in steps 50-54. While step 49 may be omitted in some embodiments, it is believed that the predictive accuracy of the regression model may be improved by eliminating outliers. Any numerical criteria could be used to eliminate outliers in step 49 without departing from the scope of the invention. By returning to step 46 after outliers have been eliminated, the overall accuracy of the equations determined by the regression analysis can be improved. However, a single regression could be used without departing from the scope of the invention.

In a subsequent pass through step 44 regression is performed with the outliers eliminated but using all of the statistic types that were used the first time regression was performed. Alternatively, the subsequent regression(s) performed could simply use those statistic types that were not eliminated by the first regression analysis due to co-linearity and/or significance issues. Subsequent regression(s) could also use other statistic types that are forced to be a part of the regression. While a stepwise linear regression can be used in subsequent passes, other types of multiple linear regression could also be used.

When the final regression has been performed (which could be the first regression in some embodiments) the regression produces a set of coefficients (and a constant which may be zero) associated with each significant statistic type that may be used to create a linear equation that is predictive of the dependent variable (e.g. market price, price/earnings ratio, price/book value, etc.) used during the regression. In this linear equation, the coefficient associated with a particular statistic type would be multiplied by the numerical value of the particular statistic having that statistic type for each particular stock. The products of the coefficients and statistics would then be summed (some values could be negative) to obtain an estimate of over-valuation or under-valuation for a particular stock. In some embodiments, the estimate may simply be a ratio of a predicted value (calculated using the regression) to an actual value.

In some embodiments, a related statistical technique may be used. It is possible that two statistic types have predictive value that is somewhat independent but one of those two statistic types would be eliminated from the regression due to colinearity. An example might be return on average equity for the current quarter and core return on equity for the current quarter. In these instances, and other instances, it may be desirable to perform steps 46-50 separately with one equation for one of these statistic types and one equation for the other statistic type. Then, a weighted average of the two can be computed and the weighted average may produce a more accurate result.

In addition, the same type of weighted average can be used when linear regression is performed separately for each of multiple dependent variables that may be used to estimate over-valuation or under-valuation. The overall prediction of over-valuation or under-valuation may be calculated using each of the multiple equations. A weighted sum of the results produced by each equation may be calculated and averaged to produce a final prediction. When this type of calculation is used, certain statistic types may be common to multiple over-valuation or under-valuation predictive equations. In other words, when the various regressions are performed to produce the equations in question, various statistics may be used in multiple regressions and found to be significant and therefore included in multiple equations. The weights can be even or can be uneven depending upon the particular application and on experience with the predictive value of various statistics. The weights can also be determined based upon the f-ratios for each equation.

The inventor has used the techniques discussed herein for calculating a prediction of over-valuation or under-valuation for financial institution stocks. While the number of equations and statistic types in each equation may change from time period to time period, the following equations represent one set of predictors of over-valuation or under-valuation and their weighted average for a particular time period. The X values in each equation constitute coefficients and/or constants that were determined in step 46 using the stepwise linear regression. In these equations, the first equation is a ratio of predicted price/book to actual price/book value. The 2nd-4th equations are ratios of predicted market price to actual market price calculated using different regressions. The 5th equation is a weighted average of these values that produces, for a particular stock, a value representing the degree of over-valuation (numbers less than one) or under-valuation (numbers greater than one) when compared to other stocks within the group.
KPB=(X₀₀+X₀₁BZ+X₀₂AB+X₀₃BP−X₀₄AK−X₀₅AJ+X₀₆AO)/N
KP1=(X₁₁CRELST3+X₁₂BZ+X₁₃Q−X₁₄AK+X₁₅U−X₁₆MTGSVC_{—}S+X₁₇AMINTNYS−X₁₈BL)/D
KP2=(X₂₁CRELST3+X₂₂BZ+X₂₃Q−X₂₄AK+X₂₅U−X₂₆MTGSVC_{—}S+X₂₇AMINTNYS)/D
KP3=(X₃₁ CRELST3+X₃₂Q+X₃₃COVERBIG+X₃₄U−X₃₅MTGSVC_{—}S+X₃₆CC−X₃₇CH+X₃₈AMINTNYS)/D
Kest=(4KP3+3KP2+2KP1+KPB)/10

In step 52, certain stocks may be eliminated from consideration for inclusion in a stock portfolio based upon certain elimination criteria. Preferably, the criterion chosen may be some criterion that indicates that investment relating to a particular stock may be risky or that the model's prediction of undervaluation or overvaluation is subject to error due to other circumstances. In such cases, the predictive model may not closely predict whether or not a stock is overvalued or undervalued based upon the linear regression analysis. Note that step 52 could have been performed prior to step 44 and/or in conjunction with step 46 without departing from the scope of the invention. Also, elimination may be performed both before step 44 and after step 44 (or before or after any of steps 46-50) without departing from the scope of the invention.

In this embodiment, one criterion that may be used to eliminate stocks may be whether or not the company associated with the stock is profitable or not. In the financial institution example, a financial institution that is losing money may be eliminated from consideration for the portfolio and may be eliminated before step 44 or 46. Alternatively, a financial institution with losses of a particular magnitude or with a particular magnitude as compared to the financial institution's total equity or assets may be used to eliminate a particular stock. This criterion may or may not be a useful criterion to use either for financial institutions or for other types of businesses when deciding whether or not to eliminate a stock from consideration for inclusion in the portfolio and/or from consideration in the data analyzed in steps 44-50.

Another criterion that might be used in step 52 to eliminate certain stocks is whether the price-to-earnings ratio is less than a particular threshold or greater than a particular threshold. A stock with a very high price-to-earnings ratio as compared to other stocks in the same industry may indicate that factors other than those used in the analysis are affecting price. A stock with an unusually low price-to-earnings ratio as compared to stocks in the industry may indicate a stock associated with a company that is having some type of difficulty not necessarily reflected in financial data. In applying the invention to financial institutions, for example, one may want to eliminate institutions from consideration with a price-to-earnings ratio below six or over thirty-five. However, any type of threshold may be used without departing from the scope of the invention. In addition, one may not wish to use price-to-earnings ratio as an elimination criterion and this elimination criterion could be omitted without departing from the scope of the invention. Those of skill in the art will understand that step 52 could also be omitted without departing from the scope of the invention.

The above discussed regression techniques might also be used in a different way in connection with step 52 to eliminate certain stocks based upon elimination criteria. In the financial institution example, the inventor has used regression analysis to create an elimination criteria based upon a policy capturing model for required reserves. In this policy capturing model, the regression provides a consensus estimate of what each financial institution in the industry thinks is the required amount of reserves it should maintain. The consensus predicted value of required reserves may then be used to eliminate stocks of financial institutions with reserves (or a ratio of actual reserves to the consensus required reserves calculated) under a particular threshold. In this embodiment, the inventor has sometimes eliminated from consideration financial institutions that are underreserved where the reserves are below seventy-five percent of the prediction by the model calculated using actual data for the group of financial institutions. The reason for eliminating these stocks based upon this criteria is that an underreserved bank may have a significant charge in order to reserve sufficient funds over the next six months. Such a charge may result in a significant change in share price which may or may not be predictable.

Based upon experimentation, the inventor has determined that the following variables discussed above may be statistically significant in determining an estimate of what financial institutions think the required reserve amount is based upon the particular financial condition of a bank: Othnpa, CC, CD, CH, CK, CN, CF, and CM. Using the above multiple linear regression techniques to determine the coefficients and constants for a linear equation based upon significant statistics, the following equation was determined to estimate the amount of required reserves for one particular time period. As was the case above, a series of different equations to estimate the amount of required reserves could be used in a weighted average computed without departing from the scope of the invention.
req_res=X₀+X₁Othnpa+X₂CC+X₃CK+X₄CN

Also, as discussed above in connection with steps 44-49, outliers may be eliminated when computing an estimate of required reserves. Outliers could be eliminated by eliminating those financial institutions whose reserves are significantly higher or lower than the consensus predicted amount of reserves by a specific amount of standard deviations. Again, in this embodiment, institutions with reserves with more or less than 3.1 standard deviations from the consensus predicted amount of reserves may be eliminated. These outliers may be eliminated either before or after the second linear regression to determine the predicted reserve amount is performed, but preferably before.

Another elimination criterion that may be used in step 52 are stocks with a liquidity below a certain value. For example, the techniques of the present invention may be used to create a mutual fund or hedge fund containing investments that were chosen based upon the invention. When purchasing stock for a fund, it may be required to purchase a significant amount of the stock and/or sell a significant amount of the stock. Generally, it is desirable that a stock have sufficient liquidity such that the purchasing or sale of the stock by the fund does not have a significant impact on market price. Accordingly, one may choose to eliminate certain stocks from consideration for inclusion in the portfolio in step 52 based upon a certain liquidity threshold. Another elimination criteria is rate sensitivity which measures the extent to which earnings might be affected by large changes in overall interest rates. Another elimination criteria may be a recent dramatic price change in share price over the prior month.

Other types of elimination criteria may also be used without departing from the scope of the invention. For example, it was noted above that price-to-earnings ratio could be used as a criterion. The price-to-book value ratio may also be used. However, this criteria does not necessarily have to be used and any threshold could be used without departing from the scope of the invention.

In step 54, trading in a portfolio is conducted based upon undervalued and/or overvalued stocks that were determined to be undervalued and/or overvalued using the regression model created in steps 44 through 48. Where stocks are undervalued, the stock may be purchased, a futures contract on the stock may be purchased, and options on the stock may be bought or sold and included in portfolio 40. Alternatively, where stocks are overvalued, a stock that is currently in the portfolio may be sold, the stock may be sold short, one may sell futures contracts on the stock or one may buy or sell options on the stock. Generally, a plurality of overvalued and/or undervalued stocks will be acted upon in this manner to spread risk among a portfolio of undervalued and/or overvalued stocks, options and/or futures. Note that any of the above actions and/or types of investments made be purchased or sold without departing from the scope of the invention. For example, the model could be used simply to buy and sell stocks without buying or selling futures contracts or options without departing from the scope of the invention. Also, one may choose to exercise existing options based upon the model without departing from the scope of the invention. One may also choose to buy or sell options based upon the model without departing from the scope of the invention.

The above techniques may be further enhanced by subcategorizing stocks in a group of stocks and using the above techniques on each subset. For example, for financial institutions, one could make multiple groups of financial institutions based upon the total average dollar value of shares traded each day (or by market capitalization or by total asset-size). One could then use the above techniques and predict over-valuation or under-valuation both as compared to other stocks within the subset and compared with the entire group of stocks as a whole. When using this technique, one would again have multiple measures of over-valuation or under-valuation to take into account in making investment decisions. A weighted average of the results for a stocks subset and for the entire group could also be calculated for use in making investment decisions.

While the techniques used herein may be used to make investment decisions, other factors or analysis can be used in combination with or independent of these techniques to make investment decisions for a particular portfolio without departing from the scope of the invention.

Although the present invention has been described in detail, it should be understood that various changes, substitutions and alterations can be made hereto without departing from the sphere and scope of the invention as defined by the appended claims.

To aid the patent office, and any readers of any patent issued on this application in interpreting the claims appended hereto, applicants wish to note that they do not intend any of the appended claims to invoke paragraph 6 of 35 U.S.C. §112 as it exists on the date of filing hereof unless “means for” or “step for” are used in the particular claim.

1. A method for investing, comprising:
creating an equation for a plurality of stocks, wherein the equation is created using multiple linear regression techniques to calculate a plurality of coefficients each associated with one of a plurality of statistic types that is correlated with actual market prices of the plurality of stocks wherein at least some of the plurality of statistic types comprise financial information, other than the particular stock's past market price, specific to the entity associated with the particular stock;
using the equation to estimate the degree to which ones of the plurality of stocks are over-priced or under-priced relative to the price of other ones of the plurality of stocks;
based upon the estimates made using the equation, purchasing or selling at least some stocks, futures contracts on at least some stocks, or options on at least some stocks, in the plurality of stocks.

2. The method of claim 1, further comprising:
wherein creating an equation further involves iteratively performing linear regression wherein outliers are eliminated from use in creating the equation after at least one iteration;
wherein outliers comprise stocks whose degree of over-pricing or under-pricing relative to the price of other ones of the plurality of stocks as determined by the most recent iteration of the regression exceeds a threshold multiple of standard deviations.

3. The method of claim 1, wherein at least one of the plurality of statistic types comprises a financial statistic that is non-unique to any particular stock in the plurality of stocks.

4. The method of claim 1, wherein creating an equation further comprises calculating the plurality of coefficients using at least one stepwise linear regression.

5. The method of claim 1, wherein the plurality of statistic types does not include certain statistic types that were eliminated using a correlation analysis.

6. The method of claim 1, wherein at least some stocks are rejected from consideration for purchasing or selling based upon a first elimination criterion.

7. The method of claim 6, wherein the first elimination criterion comprises at least one criteria selected from the group comprising: insufficient liquidity, operation at a loss, a dramatic recent change in share price, sensitivity to interest rate changes, a price to earnings ratio above a particular threshold, and a price to earnings ratio below a particular threshold.

8. The method of claim 6, wherein the first elimination criterion itself is determined using additional linear regression to determine a consensus prediction of the value of a particular financial statistic and wherein the first elimination criteria comprises eliminating stocks where the actual value of the particular financial statistic for a stock exceeds a threshold variance from the consensus prediction of the value of the particular financial statistic for the stock.

9. The method of claim 1, wherein at least some of the plurality of statistics comprise data that must be reported to a government entity.

10. The method of claim 1, further comprising:
for the at least some of the plurality of stocks, identifying an overvalued set of stocks and an undervalued set of stocks based upon the equation;
selling short, buying or selling futures contracts on, or buying or selling options on at least some stocks in the overvalued set of stocks; and
buying, buying or selling futures contracts on, or buying or selling options on at least some stocks in the undervalued set of stocks.

11. A method for investing, comprising:
creating an equation for a plurality of stocks, wherein the equation is created using regression techniques to calculate a plurality of coefficients each associated with one of a plurality of statistic types that is correlated with a first value measure of the plurality of stocks wherein at least some of the plurality of statistic types comprise financial information, other than the particular stock's past market price, specific to the entity associated with the particular stock;
wherein the first value measure comprises a value measure selected from the group consisting of actual market price, price to earnings ratio, price to book value ratio, and price to revenue ratio;
using the equation to estimate the degree to which ones of the plurality of stocks are over-valued or under-valued relative to the plurality of stocks as a whole;
based upon the estimates made using the equation, purchasing or selling at least some stocks, futures contracts on at least some stocks, or options on at least some stocks, in the plurality of stocks.

12. The method of claim 11, further comprising:
for the at least some of the plurality of stocks, identifying an overvalued set of stocks and an undervalued set of stocks based upon the equation;
selling short, buying or selling futures contracts on, or buying or selling options on at least some stocks in the overvalued set of stocks; and
buying, buying or selling futures contracts on, or buying or selling options on at least some stocks in the undervalued set of stocks.

13. The method of claim 11, further comprising:
at some point before final creation of the equation, eliminating at least one stock from the plurality of stocks for use in determining the equation based upon a numerical criteria indicating that the at least one stock comprises an outlier from a statistical point of view.

14. The method of claim 11,
wherein the equation further comprises a weighted average of results produced from a plurality of additional equations; and
wherein each of the plurality of additional equations is created using regression techniques.

15. The method of claim 11, wherein at least some stocks are rejected from consideration for purchasing or selling based upon a first elimination criterion.

16. The method of claim 15, wherein the first elimination criterion comprises at least one criteria selected from the group comprising: insufficient liquidity, operation at a loss, a dramatic recent change in share price, sensitivity to interest rate changes, a price to earnings ratio above a particular threshold, and a price to earnings ratio below a particular threshold.

17. The method of claim 15, wherein the first elimination criterion itself is determined using additional regression to determine a consensus prediction of the value of a particular financial statistic and wherein the first elimination criteria comprises eliminating stocks where the actual value of the particular financial statistic for a stock exceeds a threshold variance from the consensus prediction of the value of the particular financial statistic for the stock.

18. The method of claim 11, wherein at least some of the plurality of statistic types comprise statistics that must be reported to a government entity.

19. An investment portfolio, comprising:
a plurality of investments owned by an individual or entity, wherein at least some investments in the portfolio comprise investments that were purchased at least partially in response to a valuation estimate estimating the degree of over-valuation or under-valuation of each of a plurality of stocks relative to the plurality of stocks as a whole;
wherein ones of the plurality of investments comprise a stock, option on an individual stocks, or futures contract on an individual stocks,
wherein the valuation estimate was determined by
creating an equation for the plurality of stocks, wherein the equation is created using regression techniques to calculate a plurality of coefficients each associated with one of a plurality of statistic types that is correlated with a first value measure of the plurality of stocks wherein at least some of the plurality of statistic types comprise financial information, other than the particular stock's past market price, specific to the entity associated with the particular stock;
wherein the first value measure comprises a value measure selected from the group consisting of actual market price, price to earnings ratio, price to book value ratio, and price to revenue ratio;
using the equation to estimate the degree to which ones of the plurality of stocks are over-valued or under-valued relative to the plurality of stocks as a whole.

20. The stock portfolio of claim 19,
wherein the value estimate was further determined by at some point before final creation of the equation, eliminating at least one stock from the plurality of stocks for use in determining the equation based upon a numerical criteria indicating that the at least one stock comprises an outlier from a statistical point of view.

21. The stock portfolio of claim 19,
wherein the equation further comprises a weighted average of results produced from a plurality of additional equations; and
wherein each of the plurality of additional equations is created using regression techniques.

22. The stock portfolio of claim 19,
wherein at least some stocks are rejected from consideration for inclusion in the portfolio based upon a first elimination criterion.

23. The stock portfolio of claim 22,
wherein the first elimination criterion comprises at least one criteria selected from the group comprising: insufficient liquidity, operation at a loss, a dramatic recent change in share price, sensitivity to interest rate changes, a price to earnings ratio above a particular threshold, and a price to earnings ratio below a particular threshold.

24. The stock portfolio of claim 22,
wherein the first elimination criterion itself is determined using additional regression to determine a consensus prediction of the value of a particular financial statistic and wherein the first elimination criteria comprises eliminating stocks where the actual value of the particular financial statistic for a stock exceeds a threshold variance from the consensus prediction of the value of the particular financial statistic for the stock.

25. The stock portfolio of claim 19,
wherein at least some of the plurality of statistic types comprise statistics that must be reported to a government entity.
